(19) United States
(12) Patent Application Publication
(10) Pub. No.: US 2022/0147169 A1
(43) Pub. Date: May 12, 2022

(54) PIEZOELECTRIC TRANSDUCER ARRAY

(71) Applicant: Sentons Inc., Grand Cayman (KY)

(72) Inventors: Samuel W. Sheng, Saratoga, CA (US); Lapoe E. Lynn, Los Altos, CA (US); Jess J. Lee, Woodside, CA (US)

(21) Appl. No.: 17/519,362

(22) Filed: Nov. 4, 2021

Related U.S. Application Data
(60) Provisional application No. 63/111,256, filed on Nov. 9, 2020.

(51) Int. Cl. G06F 3/043; G06V 40/12; G06F 3/044; G06V 40/13; B06B 1/02; B06B 1/06

(52) U.S. Cl. CPC G06F 3/043; G06V 40/1347; G06F 3/0443; G06F 2203/04106; B06B 1/0207; B06B 1/0696; G06F 2203/04105; G06V 40/1306

(57) ABSTRACT

An assembly is configured to be coupled to a propagating medium. The assembly includes a first conductive layer including a first set of parallel conductors, a second conductive layer including a second set of parallel conductors, and a piezoelectric material layer between the first conductive layer and the second conductive layer. Different piezoelectric transducer nodes are formed at intersections between the first set of parallel conductors and the second set of parallel conductors.

### CROSS REFERENCE TO OTHER APPLICATIONS

This application claims priority to U.S. Provisional Patent Application No. 63/111,256 entitled ULTRASONIC FULL-DISPLAY TOUCH, FORCE, AND FINGERPRINT SENSOR filed Nov. 9, 2020 which is incorporated herein by reference for all purposes.

### BACKGROUND OF THE INVENTION

In response to a mechanical stress, a piezoelectric material will give off a charge to create a voltage difference. Conversely, this effect is reversible when, in response to an applied voltage, a piezoelectric material will undergo a mechanical change. By taking advantage of this property, a piezoelectric device can be used as a sensor to detect a mechanical change as well as to mechanically vibrate an object. However, current conventional piezoelectric devices are often too bulky to use in many electronic device applications. Additionally, currently best performing piezoelectric materials include lead (e.g., lead zirconate titanate) and its handling and disposal can lead to dangerous health and environmental consequences.

### BRIEF DESCRIPTION OF THE DRAWINGS

Various embodiments of the invention are disclosed in the following detailed description and the accompanying drawings.

FIG. 1A is a diagram illustrating an embodiment of a piezoelectric assembly.

FIG. 1B is a diagram illustrating an embodiment of utilizing a piezoelectric assembly to propagate and receive signals.

FIG. 1C is a diagram illustrating embodiments of a piezoelectric material layer of a piezoelectric assembly.

FIG. 2 is a block diagram illustrating an embodiment of a system for detecting a touch input.

FIG. 3 is a flowchart illustrating an embodiment of a process for calibrating and validating touch detection.

FIG. 4 is a flowchart illustrating an embodiment of a process for detecting a user touch input.

FIG. 5 is a flowchart illustrating an embodiment of a process for determining a location associated with a disturbance on a surface.

FIG. 6 is a flowchart illustrating an embodiment of a process for determining time domain signal capturing of a disturbance caused by a touch input.

FIG. 7 is a flow chart illustrating an embodiment of a process comparing spatial domain signals with one or more expected signals to determine touch contact location(s) of a touch input.

FIG. 8 is a flowchart illustrating an embodiment of a process for selecting a selected hypothesis set of touch contact location(s).

FIG. 9 is a flowchart illustrating an embodiment of a process of determining a force associated with a user input.

FIG. 10 is a flowchart illustrating an embodiment of a process for determining an entry of a data structure used to determine a force intensity identifier.

FIG. 11 includes graphs illustrating examples of a relationship between a normalized amplitude value of a measured disturbance and an applied force

FIG. 12 is a flowchart illustrating an embodiment of a process for determining a combined force measure.

FIG. 13 is a flowchart illustrating an embodiment of a process for processing a user touch input.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A piezoelectric sensor can be used to detect a touch input on an electronic device (e.g., mobile device). For example, by propagating an ultrasonic signal through a touch input medium of a device using a piezoelectric transmitter and detecting an effect of the propagated signal by a touch input using a piezoelectric receiver, a touch location and/or force can be detected. However, if the touch input medium of the device is a lossy material or is coupled to a lossy material that absorbs the ultrasonic signal trying to be propagated, the piezoelectric transmitters and receivers need to be placed close to the location where the touch input is desired to be detected. However, it may not be possible to place traditional piezoelectric devices where desired. For example, if detection is desired on a screen surface, traditional non-transparent piezoelectric transmitters and sensors cannot be placed over a screen area where touch input detection is desired. Additionally, even if touch detection is desired on a non-transparent medium, coupling a large number of piezoelectric devices to the medium may introduce cost and manufacturing challenges.

A new type of piezoelectric device described herein solves many of these challenges. In some embodiments, an assembly is coupled to a propagating medium that includes a first conductive layer including a first set of parallel conductors, a second conductive layer including a second set of parallel conductors, and a piezoelectric material layer between the first conductive layer and the second conductive layer. For example, the piezoelectric device assembly includes three layers that are deposited on a base substrate. In this example, a series of parallel transparent conductors are formed (e.g., a conductive oxide such as indium-tin-oxide or zinc-oxide) on a layer. Next a layer of transparent piezoelectric material is deposited (e.g., aluminum nitride or other lead-free piezoelectric materials). Then another series of parallel transparent conductors are deposited, oriented perpendicularly to the initial series of parallel conductors. After formation of the assembly, the entire assembly can be laminated to a display, (e.g., as in a mobile device application). In some embodiments, the conductive layers of the assembly are electrically connected to circuitry that provides a signal to be propagated by the assembly and receives a disturbed version of the propagated signal for analysis to detect a touch input.

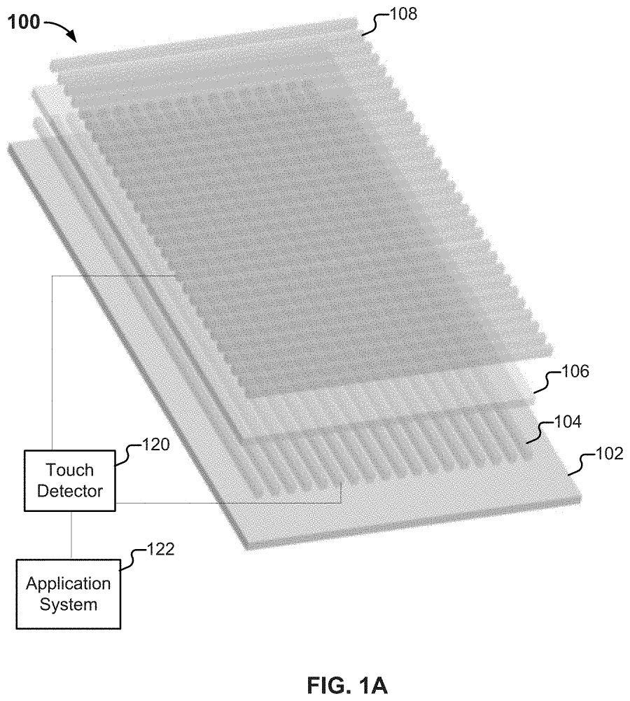

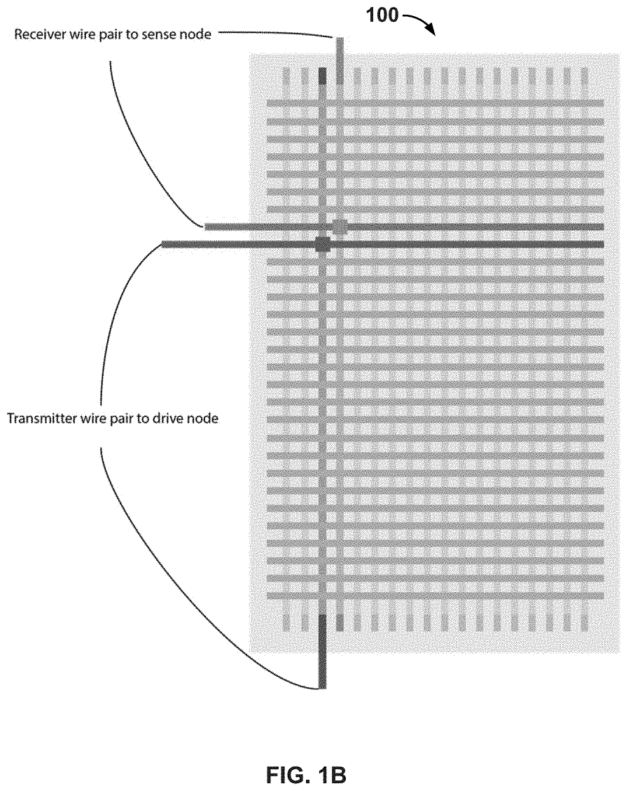

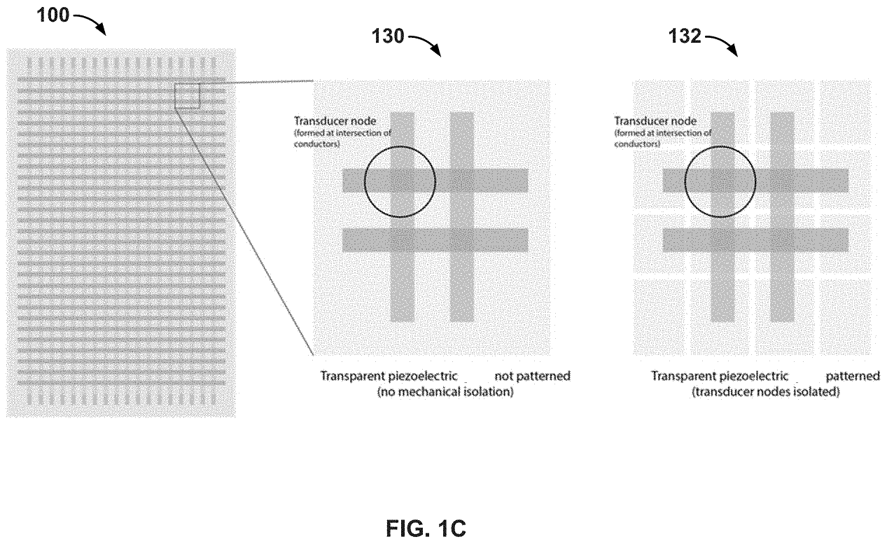

FIG. 1A is a diagram illustrating an embodiment of a piezoelectric assembly. For example, assembly 100 forms a grid of transducers for detecting a touch input (e.g., detect location, force, fingerprint, etc.).

Layers shown in FIG. 1A form piezoelectric transducers that can be used to propagate a signal on to propagating medium 102 for touch input detection. For example, piezoelectric transducer(s) functioning as transmitter(s) physically vibrate propagating medium 102 to propagate an ultrasonic, acoustic, or sound signal on to the substrate of propagating medium 102. When a touch input is provided on propagating medium 102, the propagated signal is disturbed and piezoelectric transducer(s) functioning as receiver(s) receive the disturbed signal for analysis to detect the touch input. Examples of propagating medium 102 include glass, plastic, metal, or any other material able to propagate an ultrasonic signal/wave. Because assembly 100 is able to place piezoelectric transducers directly under the area where touch input is to be detected, assembly 100 is able to function on a lossy propagating medium and utilize a piezoelectric material that trades some performance for being lead-free. In some embodiments, propagating medium 102 serves as the substrate for lamination of layers that form piezoelectric transmitters/receivers. In some embodiments, a front side of propagating medium 102 is the surface where touch input is provided by users and an obverse back side of propagating medium 102 is where the shown layers are coupled to propagating medium 102.

The layers of assembly 100 include first conductive layer 104, piezoelectric material layer 106, and a second conductive layer 108. In some embodiments, these layers are deposited on to the substrate of propagating medium 102 during manufacturing. First conductive layer 104 includes a series of parallel conductors (e.g., metal conductors) with gaps in between them to electrically isolate each other. For example, rows of long parallel conductors (e.g., each conductor less than 0.1 millimeter in width but running an entire length dimension of a touch input detection area, each conductor separated by a gap of less than 0.1 millimeter) are deposited on to propagating medium 102. In some embodiments, the parallel conductors of layer 106 are made of a transparent or semi-transparent material (e.g., indium-tin-oxide, zinc-oxide, or another conductive oxide) to allow a touch detection using an assembly over a display surface (e.g., propagating medium 102 is a cover glass of an electronic display device). To further enhance electrical isolation, in some embodiments, one or more of the parallel conductors that are not being used for either transmission or reception of the ultrasonic signal are tied to a low impedance or electrically grounded.

Piezoelectric material layer 106 is made of a material that exhibits a piezoelectric effect (e.g., generates an electric charge in response to mechanical stress). In some embodiments, the piezoelectric material layer 106 is made of a lead-free transparent or semi-transparent material that is deposited (e.g., aluminum nitride).

Second conductive layer 108 includes another series of parallel conductors (e.g., metal conductors) with gaps in between them to electrically isolate each other. For example, rows of parallel conductors (e.g., each conductor less than 0.1 millimeter in width but running an entire length dimension of a touch input detection area, each conductor separated by a gap of less than 0.1 millimeter) are oriented perpendicular to the series of parallel conductors of first conductive layer 104. In some embodiments, the parallel conductors of layer 108 are made of a deposited transparent or semi-transparent material (e.g., indium-tin-oxide, zinc-oxide, or another conductive oxide) to allow a touch detection using an assembly over a display surface. To further enhance electrical isolation, in some embodiments, one or more of the parallel conductors that are not being used for either transmission or reception of the ultrasonic signal are tied to a low impedance or electrically grounded.

In some embodiments, assembly 100 is laminated to a display, (e.g., electronic mobile device display). In some embodiments, to promote bonding between the different layers of assembly 100 and/or with a display, a bonding promoter is utilized. In many applications, it may be desirable for the bonding promoter to be transparent, thin, and not impact electric field formation in the piezoelectric material layer, and silicon dioxide and/or silicon nitride is utilized as the bonding promoter.

Although FIG. 1A has been simplified to show only one connection to layer 104 from touch detector 120 and one connection to layer 108 from touch detector 120, touch detector 120 (e.g., application-specific integrated circuit chip) is connected to each different parallel conductor of layer 104 and each different parallel conductor of layer 108 and is able to individually address the conductors. In some embodiments, since the number of parallel conductors from layers 104 and 108 can number in the thousands, to minimize the number of electrical input/output pins on touch detector 120, one or more multiplexing (e.g., functioning as both multiplexor and/or demultiplexor) circuits are placed in signal pathway(s) between the conductors of layers 104/108 and touch detector 120. For example, the multiplexing circuit allows a same connection between touch detector 120 and the multiplex circuit to selectively connect (e.g., via addressing or control signal) to any of a plurality of different parallel conductors connected to the multiplexing circuit. In some embodiments, the multiplexing circuit is implemented using thin-film driver transistors of a display laminated to assembly 100. In some embodiments, touch detector 120 includes one or more of the following: an integrated circuit chip, a printed circuit board, a processor, and other electrical components and connectors. Detector 120 determines and sends signals to be propagated by piezoelectric transducers of assembly 100. Detector 120 also receives the signals detected by piezoelectric transducers of assembly 100. The received signals are processed by detector 120 to determine whether a disturbance associated with a user input has been detected at a location on a surface of medium 102 associated with the disturbance. Detector 120 is in communication with application system 122. Application system 122 uses information provided by detector 120. For example, application system 122 receives from detector 120 a location identifier and/or a force identifier associated with a user touch input that is used by application system 122 to control configuration, setting or function of a device, operating system and/or application of application system 122.

In some embodiments, application system 122 includes a processor and/or memory/storage. In other embodiments, detector 120 and application system 122 are at least in part included/processed in a single processor. An example of data provided by detector 120 to application system 122 includes one or more of the following associated with a user indication: a location coordinate along a one-dimensional axis, a gesture, simultaneous user indications (e.g., multi-touch input), a feature in a human fingerprint, a time, a status, a direction, a velocity, a force magnitude, a proximity magnitude, a pressure, a size, and other measurable or derived information.

FIG. 1B is a diagram illustrating an embodiment of utilizing a piezoelectric assembly to propagate and receive signals. For example, assembly 100 of FIG. 1B is the same assembly 100 shown in FIG. 1A.

The perpendicular orientation of the series conductors of first conductive layer 104 and the series conductors of second conductive layer 108 intersect at certain portions to create a grid of piezoelectric transducer nodes at the intersections that can be utilized as individual transmitting/sensing elements.

A transducer node created by the intersection can either behave as a transmitter, a receiver, or both. Each transducer node element is operated differentially; each transducer node element (e.g., either as transmitter or receiver) has two wires to either drive or receive a signal. FIG. 1B shows one conductor being selected from first conductive layer 104 and one conductor being selected from second conductive layer 108 where a differential signal is applied to the pair of conductors (e.g., positive component of the differential signal applied to one conductor and negative component of the differential signal applied to the other conductor) to drive a piezoelectric transducer transmitter created at the intersection of the pair. FIG. 1B also shows one conductor element selected from a first conductive layer (e.g., layer 104 shown in FIG. 1A) and one perpendicular conductor element selected from a second conductive layer (e.g., layer 108 shown in FIG. 1A) where a voltage difference can be detected between the pair of intersecting conductors to form a piezoelectric transducer receiver at the intersection of the pair.

By selecting different pairs of conductors (e.g., one from the first conductive layer 104 and one from second conductive layer 108), different corresponding transducer nodes at different corresponding intersections can be activated. For example, to active a piezoelectric transmitter, the transducer at the intersection point where the two conductor pairs intersect is the one that will be excited, since there is coherent electric field across the piezoelectric material in between the intersection. The piezoelectric material transforms the electric field into a vibration (e.g., ultrasonic), which then emits from that intersection transducer node. The signal emitted/vibrated by the piezoelectric transducer node would emanate from the node and propagate through the propagating medium (e.g., medium 102 labeled in FIG. 1A).

In some embodiments, the propagation of interest is the propagation through the thickness of the propagating medium to the other surface of the propagating medium on the other side. Then the same transducer can switch to become a receiver to detect any disturbance to the propagated signal by a touch input directly over the same transducer. In some embodiments, the propagation of interest is the propagation to another transducer located at a different intersection that functions as a signal receiver. For example, a surrounding transducer node different from the transmitter transducer node can be configured as a receiver by detecting a voltage difference at the appropriate differential conductors intersecting at the receiver transducer node. This allows detection of a disturbance to the propagated signal by a touch input at a location between the transmitter transducer node and the receiver transducer node. For example, an ultrasonic wave from the transmit transducer node travels through the substrate into one or more receiver transducer nodes; a touch input disrupted these propagating signal waves, which is detected by touch detector circuitry to register a touch with the sensor. The presence of the disturbance indicates a touch has occurred, and the amplitude of the disturbance is proportional to the force of the touch contact. By scanning across the array of transducer nodes, multiple touch contacts and the force associated with each contact can be determined. With a sufficient density of transducer nodes (e.g., spacing less than 0.1 mm), the individual features of a human fingerprint can be discerned, since each individual ridge/valley of a fingerprint will manifest as distinct touch contacts across the ultrasonic transducer node array.

In some embodiments, multiple different signals from a plurality of different transmitter transducer nodes of assembly 100 are vibrated/emitted/transmitted at the same time. The different signals may be able to be distinguished from one another by having each of the different signals be at different carrier frequencies and/or be encoded with a different encoding (e.g., encoded with different pseudo random binary signals). The received signal is then filtered at different appropriate frequencies and/or correlated with different corresponding reference signals to separate out the different signals.

When applying the differential signal to the pair of conductors on the two different layers of the series of parallel conductors perpendicular across the layers, the conductor pair in the different layers passes across other parts of the piezoelectric material not at the specific intersection forming the transducer node of interest. This may cause these other parts of the piezoelectric material to undesirably activate. In some embodiments, to eliminate or reduce these undesirable activations, an opposing signal is applied to the other conductors to cancel out the signal being applied to the differential pair of conductors of interest. For example, on the first conductive layer, a positive polarity component signal of a coded differential signal waveform is applied to a conductor of interest while all other conductors of the first layer or other conductors of the first layer near the conductor of interest are applied an opposite signal of the positive polarity component signal (i.e., negative polarity component signal), and on the second conductive layer, a negative polarity component signal of the coded differential signal waveform is applied to a conductor of interest while all other conductors of the second layer or other conductors of the second layer near the conductor of interest are applied an opposite signal of the negative polarity component signal (i.e., positive polarity component signal). In some embodiments, one or more of the other conductors of the first layer and/or the second layer are tied to a low impedance or electrical grounded to minimize the physical extent of the undesirable activations.

Various different embodiments of different parallel conductor densities in the different conductive layers exist, leading to different densities of transducer nodes formed by the conductor intersections in the various different embodiments. In some embodiments, with the conductors in each array of the different conductive layers having a sufficiently high density (e.g., greater than 10 conductors/mm, or 100 transducer nodes per square millimeter), sensing of a fingerprint may become possible, since the individual ridges and valleys of the fingerprint are interpreted as distinct touches and/or different forces/pressures. In some embodiments, assembly 100 is utilized as a unified fingerprint/touch/force sensor, allowing fingerprint detection across the entire lens surface over an electronic display.

In various embodiments, each conductor of the series of parallel conductors in the different conductive layers is individually addressable, and a form of multiple access technique is employed (e.g., modulating different frequencies across different transmitter pairs, accessing each transmitter pair at different times, or using different digitally encoded waveforms in each transmitter pair, combinations of these techniques, etc.). In one embodiment, a plurality of transducer nodes transmit at the same time with the same frequency band, but utilize different digitally coded waveforms to separate the signals from different transducer nodes. The digitally coded waveforms can be structured to be immune to additive noise. Since there are many electrical noise sources present in devices like smartphones, the noise immunity from digital encoding is greatly beneficial, especially against the switching noise from the display that will be laminated to the sensor.

Given that the upper and lower conductive layers have an associated capacitance in addition to their piezoelectric nature, a capacitive (e.g., either self-capacitive or projected capacitive) touch sensing can be performed using assembly 100. For example, it is possible to detect and utilize the capacitive touch information in addition to the piezoelectric touch information to enhance performance. In some embodiments, capacitive sensing is utilized to detect a location of a touch input while piezoelectric sensing is utilized to detect a force/pressure of the touch input. In some embodiments, capacitive sensing is utilized to detect a finger touch input or a conductive stylus touch input while piezoelectric sensing is utilized to detect a gloved touch input or a non-conductive touch input. For example, touch detection using capacitance requires that the object being used to touch the surface be conductive to cause a change in capacitance. However, because piezoelectric sensing detects a disturbance to a propagated active signal, touch inputs by a non-conductive object are able to be detected.

FIG. 1C is a diagram illustrating embodiments of a piezoelectric material layer of a piezoelectric assembly. For example, assembly 100 is the transducer/sensor shown in FIG. 1A. Close-up view 130 shows an embodiment of a uniform piezoelectric material layer (e.g., layer 106 shown in FIG. 1A) of assembly 100. For example, this allows a uniform layer of the piezoelectric material to be deposited or placed in between the different conductive layers. Although this uniform piezoelectric material layer is efficient in terms of manufacturing and cost, transducer performance can be improved by increasing mechanical isolation between the different piezoelectric transducer nodes being formed at the conductor intersections. For example, the piezoelectric material layer is patterned to separate the piezoelectric material for each different piezoelectric transducer node. Close-up view 132 shows a different embodiment where patterning has been utilized to leave a gap between the piezoelectric material portions for different piezoelectric transducer nodes to form a grid of separate piezoelectric material portions for different transducer nodes.

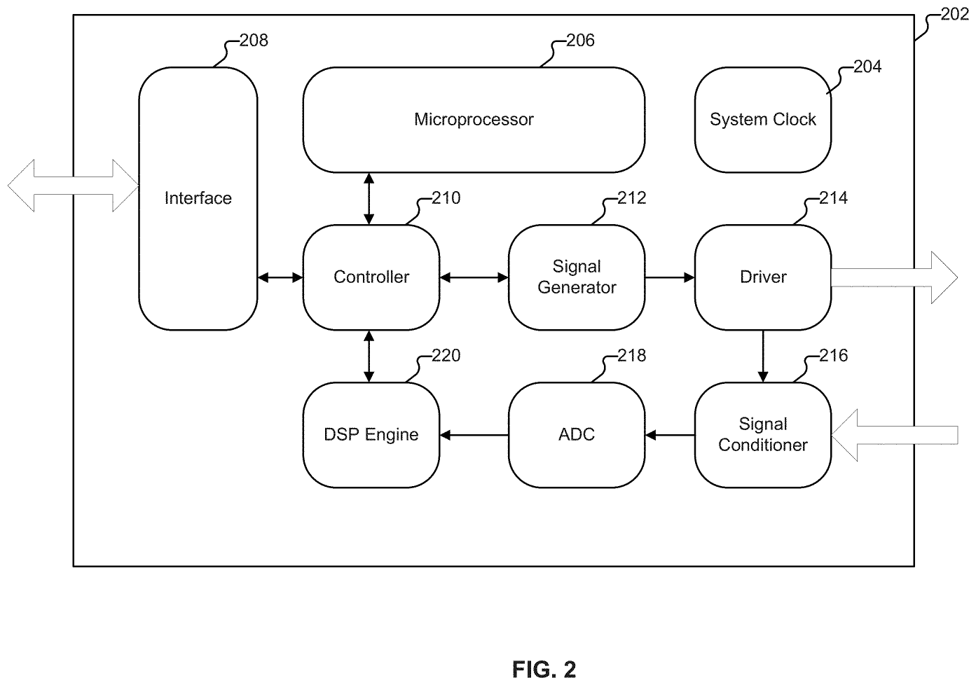

FIG. 2 is a block diagram illustrating an embodiment of a system for detecting a touch input. In some embodiments, touch detector 202 is included in touch detector 120 of FIG. 1A. In some embodiments, the system of FIG. 2 is integrated in an integrated circuit chip. Touch detector 202 includes system clock 204 that provides a synchronous system time source to one or more other components of detector 202. Controller 210 controls data flow and/or commands between microprocessor 206, interface 208, DSP engine 220, and signal generator 212. In some embodiments, microprocessor 206 processes instructions and/or calculations that can be used to program software/firmware and/or process data of detector 202. In some embodiments, a memory is coupled to microprocessor 206 and is configured to provide microprocessor 206 with instructions.

Signal generator 212 generates signals to be used to propagate signals such as signals propagated by piezoelectric transducer nodes of assembly 100 of FIGS. 1A-1C that function as transmitters. For example, signal generator 212 generates pseudorandom binary sequence signals that are converted from digital to analog signals. Different signals (e.g., a different signal for each node of a plurality of different piezoelectric transducer nodes to transmit concurrently) may be generated by signal generator 212 by varying a phase of the signals (e.g., code division multiplexing), a frequency range of the signals (e.g., frequency division multiplexing), or a timing of the signals (e.g., time division multiplexing). In some embodiments, spectral control (e.g., signal frequency range control) of the signal generated by signal generator 212 is performed. For example, microprocessor 206, DSP engine 220, and/or signal generator 212 determines a windowing function and/or amplitude modulation to be utilized to control the frequencies of the signal generated by signal generator 212. Examples of the windowing function include a Hanning window and raised cosine window. Examples of the amplitude modulation include signal sideband modulation and vestigial sideband modulation. In some embodiments, the determined windowing function may be utilized by signal generator 212 to generate a signal to be modulated to a carrier frequency. The carrier frequency may be selected such that the transmitted signal is an ultrasonic signal. For example, the transmitted signal to be propagated through a propagating medium is desired to be an ultrasonic signal to minimize undesired interference with sonic noise and minimize excitation of undesired propagation modes of the propagating medium. The modulation of the signal may be performed using a type of amplitude modulation such as signal sideband modulation and vestigial sideband modulation to perform spectral control of the signal. The modulation may be performed by signal generator 212 and/or driver 214. Driver 214 receives the signal from generator 212 and drives one or more piezoelectric transducer nodes of assembly 100 of FIGS. 1A-1C functioning as transmitter(s) to propagate signals through a medium.

A signal detected by a sensor/receiver such as one or more piezoelectric transducer nodes of assembly 100 of FIGS. 1A-1C functioning as sensor(s) is received by detector 202 and signal conditioner 216 conditions (e.g., filters) the received analog signal for further processing. For example, signal conditioner 216 receives the signal outputted by driver 214 and performs echo cancellation of the signal received by signal conditioner 216. The conditioned signal is converted to a digital signal by analog-to-digital converter 218. The converted signal is processed by digital signal processor engine 220. For example, DSP engine 220 separates components corresponding to different signals propagated by different transmitters from the received signal and each component is correlated against a reference signal. The result of the correlation may be used by microprocessor 206 to determine a location associated with a user touch input. For example, microprocessor 206 compares relative differences of disturbances detected in signals originating from different transmitters and/or received at different receivers/sensors to determine the location.

In some embodiments, DSP engine 220 determines a location of a touch input based on which signal path(s) in the propagating medium between a transmitter and a sensor have been affected by the touch input. For example, if the signal transmitted by transmitter 104 and directly received at sensor 105 has been detected as disturbed by DSP engine 220, it is determined that a touch input has been received at a location between a first surface location of the propagating medium directly above where transmitter 104 is coupled to the propagating medium and a second surface location of the propagating medium directly above where sensor 105 is coupled to the propagating medium. By spacing transmitters and receivers close enough together (e.g., space between transmitters/receivers is less than size of object providing touch input) in areas where touch inputs are to be detected, the location of the touch input is able to be detected along an axis within spacing between the transmitters/receivers.

In some embodiments, DSP engine 220 correlates the converted signal against a reference signal to determine a time domain signal that represents a time delay caused by a touch input on a propagated signal. In some embodiments, DSP engine 220 performs dispersion compensation. For example, the time delay signal that results from correlation is compensated for dispersion in the touch input surface medium and translated to a spatial domain signal that represents a physical distance traveled by the propagated signal disturbed by the touch input. In some embodiments, DSP engine 220 performs base pulse correlation. For example, the spatial domain signal is filtered using a match filter to reduce noise in the signal. A result of DSP engine 220 may be used by microprocessor 206 to determine a location associated with a user touch input. For example, microprocessor 206 determines a hypothesis location where a touch input may have been received and calculates an expected signal that is expected to be generated if a touch input was received at the hypothesis location and the expected signal is compared with a result of DSP engine 220 to determine whether a touch input was provided at the hypothesis location.

Interface 208 provides an interface for microprocessor 206 and controller 210 that allows an external component to access and/or control detector 202. For example, interface 208 allows detector 202 to communicate with application system 122 of FIG. 1A and provides the application system with location and/or pressure/force information associated with a user touch input.

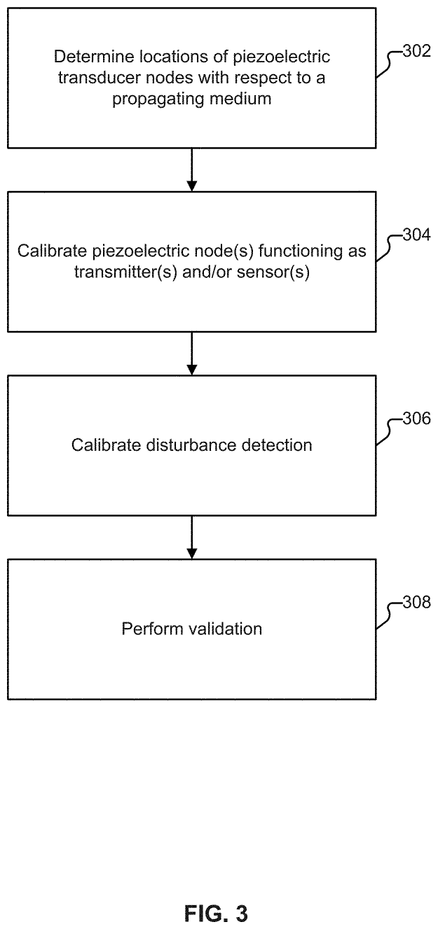

FIG. 3 is a flowchart illustrating an embodiment of a process for calibrating and validating touch detection. In some embodiments, the process of FIG. 3 is used at least in part to calibrate and validate the system of FIGS. 1A-1C and/or the system of FIG. 2. At 302, locations of piezoelectric transducer nodes with respect to a propagating medium are determined. For example, locations of piezoelectric transducer nodes on assembly 100 shown in FIGS. 1A-1C are determined with respect to their exact location on propagating medium 102. In some embodiments, determining the locations includes receiving location information. In various embodiments, one or more of the locations may be fixed (e.g., relative location between nodes) and/or variable (e.g., location of entire assembly 100 with respect to a display).

At 304, piezoelectric transducer node(s) functioning as transmitter(s) and/or sensor(s) are calibrated. In some embodiments, calibrating the transmitter includes calibrating a characteristic of a signal driver and/or transmitter (e.g., strength). In some embodiments, calibrating the sensor includes calibrating a characteristic of a sensor (e.g., sensitivity). In some embodiments, the calibration of 304 is performed to optimize the coverage and improve signal-to-noise transmission/detection of a signal (e.g., sound signal, acoustic signal, or ultrasonic signal) to be propagated through a medium and/or a disturbance to be detected. For example, one or more components of the system of FIGS. 1A-1C and/or the system of FIG. 2 are tuned to meet a signal-to-noise requirement. In some embodiments, the calibration of 304 depends on the size and type of a transmission/propagation medium and geometric configuration of the transmitters/sensors. In some embodiments, the calibration of step 304 includes detecting a failure or aging of a transmitter or sensor. In some embodiments, the calibration of step 304 includes cycling the transmitter and/or receiver. For example, to increase the stability and reliability of a piezoelectric transmitter and/or receiver, a burn-in cycle is performed using a burn-in signal. In some embodiments, the step of 304 includes configuring at least one sensing device within a vicinity of a predetermined spatial region to capture an indication associated with a disturbance using the sensing device. The disturbance is caused in a selected portion of the input signal corresponding to a selection portion of the predetermined spatial region.

At 306, disturbance detection is calibrated. In some embodiments, a test signal is propagated through a medium such as medium 102 of FIG. 1A to determine an expected sensed signal when no disturbance has been applied. In some embodiments, a test signal is propagated through a medium to determine a sensed signal when one or more predetermined disturbances (e.g., predetermined touch) are applied at a predetermined location. Using the sensed signal, one or more components may be adjusted to calibrate the disturbance detection. In some embodiments, the test signal is used to determine a signal that can be later used to process/filter a detected signal disturbed by a touch input.

In some embodiments, data determined using one or more steps of FIG. 3 is used to determine data (e.g., formula, variable, coefficients, etc.) that can be used to calculate an expected signal that would result when a touch input is provided at a specific location on a touch input surface. For example, one or more predetermined test touch disturbances are applied at one or more specific locations on the touch input surface and a test propagating signal that has been disturbed by the test touch disturbance is used to determine the data (e.g., transmitter/sensor parameters) that is to be used to calculate an expected signal that would result when a touch input is provided at the one or more specific locations.

At 308, a validation is performed. For example, the system of FIGS. 1A-1C and/or FIG. 2 is tested using predetermined disturbance patterns to determine detection accuracy, detection resolution, multi-touch detection, and/or response time. If the validation fails, the process of FIG. 3 may be at least in part repeated and/or one or more components may be adjusted before performing another validation.

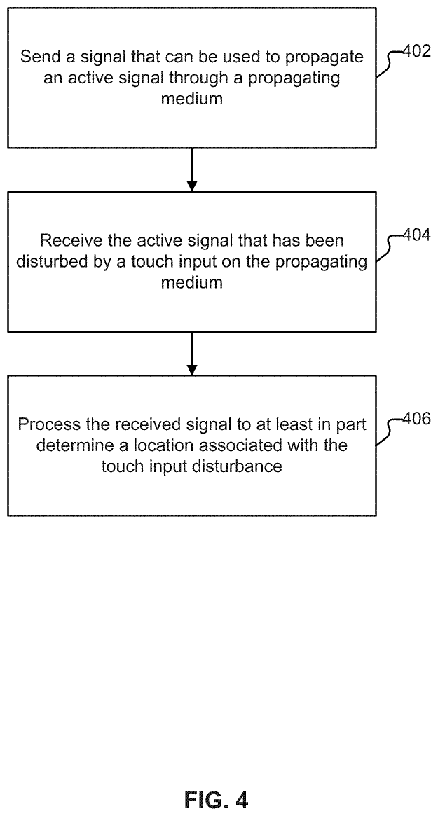

FIG. 4 is a flowchart illustrating an embodiment of a process for detecting a user touch input. In some embodiments, the process of FIG. 4 is at least in part implemented on touch detector 120 of FIG. 1A and/or touch detector 202 of FIG. 2. In some embodiments, the process of FIG. 4 is repeated as different piezoelectric transducer nodes of assembly 100 are utilized in an attempt to detect a touch input. For example, the process of FIG. 4 is repeated as each piezoelectric transducer node is activated serially in a scan order (e.g., left to right for each row by row in top to bottom progression) in an attempt to detect a touch input. In another example, only certain piezoelectric transducer nodes of assembly 100 are activated to vibrate/transmit a signal, and the process of FIG. 4 is repeated for each group of one or more piezoelectric transducer nodes of groups activated serially.

At 402, a signal that can be used to propagate an active signal through a propagating medium is sent. In some embodiments, sending the signal includes driving (e.g., using driver 214 of FIG. 2) a transmitter such as a transducer (e.g., transducer node of assembly 100 of FIGS. 1A-1C) to propagate an active signal (e.g., acoustic or ultrasonic) through a propagating medium with the surface region. In some embodiments, the propagation of interest is the propagation through the thickness of the propagating medium to the other surface of the propagating medium on the other side. In some embodiments, the propagation of interest is the propagation to another transducer located at a different conductor intersection in an array of transducers (e.g., across different transducers nodes on assembly 100).

In some embodiments, the signal includes a sequence selected to optimize autocorrelation (e.g., resulting in narrow/short peaks) of the signal. For example, the signal includes a Zadoff-Chu sequence. In some embodiments, the signal includes a pseudorandom binary sequence with or without modulation. In some embodiments, the propagated signal is an acoustic signal. In some embodiments, the propagated signal is an ultrasonic signal (e.g., outside the range of human hearing). For example, the propagated signal is a signal above 20 kHz (e.g., within the range between 80 kHz to 1000 kHz). In other embodiments, the propagated signal may be within the range of human hearing. In some embodiments, by using the active signal, a user input on or near the surface region can be detected by detecting disturbances in the active signal when it is received by a sensor on the propagating medium. By using an active signal rather than merely listening passively for a user touch indication on the surface, other vibrations and disturbances that are not likely associated with a user touch indication can be more easily discerned/filtered out. In some embodiments, the active signal is used in addition to receiving a passive signal from a user input to determine the user input.

When attempting to propagate a signal through a medium such as glass in order to detect touch inputs on the medium, the range of frequencies that may be utilized in the transmitted signal determines the bandwidth required for the signal as well as the propagation mode of the medium excited by the signal and noise of the signal.

With respect to bandwidth, if the signal includes more frequency components than necessary to achieve a desired function, then the signal is consuming more bandwidth than necessary, leading to wasted resource consumption and slower processing times.

With respect to the propagation modes of the medium, a propagation medium such as metal likes to propagate a signal (e.g., an ultrasonic/sonic signal) in certain propagation modes. For example, in the A0 propagation mode of glass, the propagated signal travels in waves up and down perpendicular to a surface of the glass (e.g., by bending the glass) whereas in the S0 propagation mode of glass, the propagated signal travels in waves up and down parallel to the glass (e.g., by compressing and expanding the glass). A0 mode is desired over S0 mode in touch detection because a touch input contact on a glass surface disturbs the perpendicular bending wave of the A0 mode and the touch input does not significantly disturb the parallel compression waves of the S0 mode. The example glass medium has higher order propagation modes such as A1 mode and S1 mode that become excited with different frequencies of the propagated signals.

With respect to the noise of the signal, if the propagated signal is in the audio frequency range of humans, a human user would be able to hear the propagated signal which may detract from the user's user experience. If the propagated signal included frequency components that excited higher order propagation modes of the propagating medium, the signal may create undesirable noise within the propagating medium that makes detection of touch input disturbances of the propagated signal difficult to achieve.

In some embodiments, the sending of the signal includes performing spectral control of the signal. In some embodiments, performing spectral control on the signal includes controlling the frequencies included in the signal. In order to perform spectral control, a windowing function (e.g., Hanning window, raised cosine window, etc.) and/or amplitude modulation (e.g., signal sideband modulation, vestigial sideband modulation, etc.) may be utilized. In some embodiments, spectral control is performed to attempt to only excite the A0 propagation mode of the propagation medium. In some embodiments, spectral control is performed to limit the frequency range of the propagated signal to be within 50 kHz to 1000 kHz.

In some embodiments, the sent signal includes a pseudorandom binary sequence. The binary sequence may be represented using a square pulse. However, modulated signal of the square pulse includes a wide range of frequency components due to the sharp square edges of the square pulse. In order to efficiently transmit the pseudorandom binary sequence, it is desirable to “smooth out” sharp edges of the binary sequence signal by utilizing a shaped pulse. A windowing function may be utilized to “smooth out” the sharp edges and reduce the frequency range of the signal. A windowing function such as Hanning window and/or raised cosine window may be utilized. In some embodiments, the type and/or one or more parameters of the windowing function are determined based at least in part on a property of a propagation medium such as medium 102 of FIG. 1A. For example, information about propagation modes and associated frequencies of the propagation medium are utilized to select the type and/or parameter(s) of the windowing function (e.g., to excite desired propagation mode and not excite undesired propagation mode). In some embodiments, a type of propagation medium is utilized to select the type and/or parameter(s) of the windowing function. In some embodiments, a dispersion coefficient, a size, a dimension, and/or a thickness of the propagation medium is utilized to select the type and/or parameter(s) of the windowing function. In some embodiments, a property of a transmitter is utilized to select the type and/or parameter(s) of the windowing function.

In some embodiments, sending the signal includes modulating (e.g., utilize amplitude modulation) the signal. For example, the desired baseband signal (e.g., a pseudorandom binary sequence signal) is desired to be transmitted at a carrier frequency (e.g., ultrasonic frequency). In this example, the amplitude of the signal at the carrier frequency may be varied to send the desired baseband signal (e.g., utilizing amplitude modulation). However, traditional amplitude modulation (e.g., utilizing double-sideband modulation) produces an output signal that has twice the frequency bandwidth of the original baseband signal. Transmitting this output signal consumes resources that otherwise do not have to be utilized. In some embodiments, single-sideband modulation is utilized. In some embodiments, in single-sideband modulation, the output signal utilizes half of the frequency bandwidth of double-sideband modulation by not utilizing a redundant second sideband included in the double-sideband modulated signal. In some embodiments, vestigial sideband modulation is utilized. For example, a portion of one of the redundant sidebands is effectively removed from a corresponding double-sideband modulated signal to form a vestigial sideband signal. In some embodiments, double-sideband modulation is utilized.

In some embodiments, sending the signal includes determining the signal to be transmitted by a transmitter such that the signal is distinguishable from other signal(s) transmitted by other transmitters. In some embodiments, sending the signal includes determining a phase of the signal to be transmitted (e.g., utilize code division multiplexing/CDMA). For example, an offset within a pseudorandom binary sequence to be transmitted is determined. In this example, each transmitter of one or more transmitters to transmit concurrently (e.g., one or more transducer nodes of assembly 100) transmits a signal with the same pseudorandom binary sequence but with a different phase/offset. The signal offset/phase difference between the signals transmitted by the transmitters may be equally spaced (e.g., 64-bit offset for each successive signal) or not equally spaced (e.g., different offset signals). The phase/offset between the signals may be selected such that it is long enough to reliably distinguish between different signals transmitted by different transmitters. In some embodiments, the signal is selected such that the signal is distinguishable from other signals transmitted and propagated through the medium. In some embodiments, the signal is selected such that the signal is orthogonal to other signals (e.g., each signal orthogonal to each other) transmitted and propagated through the medium.

In some embodiments, sending the signal includes determining a frequency of the signal to be transmitted (e.g., utilize frequency division multiplexing/FDMA). For example, a frequency range to be utilized for the signal is determined. In this example, each transmitter transmits a signal in a different frequency range as compared to signals transmitted by other transmitters. The range of frequencies that can be utilized by the signals transmitted by the transmitters is divided among the transmitters. In some cases, if the range of frequencies that can be utilized by the signals is small, it may be difficult to transmit all of the desired different signals of all the transmitters. Thus, the number of transmitters that can be utilized with frequency division multiplexing/FDMA may be smaller than can be utilized with code division multiplexing/CDMA.

In some embodiments, sending the signal includes determining a timing of the signal to be transmitted (e.g., utilize time division multiplexing/TDMA). For example, a time when the signal should be transmitted is determined. In this example, each transmitter transmits a signal in different time slots as compared to signals transmitted by other transmitters. This may allow the transmitters to transmit signals in a round-robin fashion such that only one transmitter is emitting/transmitting at one time. A delay period may be inserted between periods of transmission of different transmitters to allow the signal of the previous transmitter to sufficiently dissipate before transmitting a new signal of the next transmitter. In some cases, time division multiplexing/TDMA may be difficult to utilize in cases where fast detection of touch input is desired because time division multiplexing/TDMA slows down the speed of transmission/detection as compared to code division multiplexing/CDMA.

In some embodiments, the signal applied to the transmitter is a differential signal applied to a pair of conductors perpendicular to each other on different conductive layers sandwiching a piezoelectric material, where the intersection of the pair of conductors forms a specific activated transducer transmitter on a grid array of transducer nodes (e.g., see FIGS. 1A-1C). Because the conductors with the applied signal pass over other parts of the piezoelectric material outside the intersection, the application of the signal over the entire conductors may cause these other parts of the piezoelectric material to undesirably activate. In some embodiments, to eliminate or reduce these undesirable activations, an opposing signal is applied to the other conductors to cancel out the signal being applied to the differential pair of conductors of interest. For example, on a first conductive layer of a parallel array of linear conductors, a positive polarity component signal of a coded differential signal waveform is applied to the conductor of interest on the first conductive layer while all other conductors of the first layer or other conductors of the first layer near the conductor of interest are applied an opposite of the positive polarity component signal (i.e., negative polarity component signal), and on a second conductive layer of the parallel array of linear conductors, a negative polarity component signal of the coded differential signal waveform is applied to a conductor of interest while all other conductors of the second layer or other conductors of the second layer near the conductor of interest are applied an opposite of the negative polarity component signal (i.e., positive polarity component signal).

At 404, the active signal that has been disturbed by a touch input on the propagating medium is received. The disturbance may be associated with a user touch indication. In some embodiments, the disturbance causes the active signal that is propagating through a medium to be attenuated and/or delayed. In some embodiments, the disturbance in a selected portion of the active signal corresponds to a location on the surface that has been indicated (e.g., touched) by a user.

In some embodiments, the received signal is received at a piezoelectric transducer node via a pair of conductors perpendicular to each other on different conductive layers sandwiching a piezoelectric material. In some embodiments, the received signal was received at the same transducer node (e.g., transducer node of assembly 100) that transmitted the active signal in 402. For example, after transmitting the signal in 402, the transducer node quickly switches to a receiver mode to detect and receive the active signal that has propagated through the thickness of the propagating medium and reflected back. In some embodiments, the received signal was received at a transducer node (e.g., transducer node of assembly 100) different from the transducer node that transmitted the active signal in 402.

At 406, the received signal is processed to at least in part determine a location associated with the touch input disturbance. In some embodiments, determining the location includes extracting a desired signal from the received signal at least in part by removing or reducing undesired components of the received signal such as disturbances caused by extraneous noise and vibrations not useful in detecting a touch input. In some embodiments, components of the received signal associated with different signals of different transmitters are separated. For example, different signals originating from different transmitters are isolated from other signals of other transmitters for individual processing. In some embodiments, determining the location includes comparing at least a portion of the received signal (e.g., signal component from a single transmitter) to a reference signal (e.g., reference signal corresponding to the transmitter signal) that has not been affected by the disturbance. The result of the comparison may be used with a result of other comparisons performed using the reference signal and other signal(s) received at a plurality of sensors.

In some embodiments, receiving the received signal and processing the received signal are performed on a periodic interval. In some embodiments, determining the location includes extracting a desired signal from the received signal at least in part by removing or reducing undesired components of the received signal such as disturbances caused by extraneous noise and vibrations not useful in detecting a touch input.

In some embodiments, determining the location includes processing the received signal to determine which signal path(s) in the propagating medium between a transmitter and a sensor has been disturbed by a touch input. For example, a received signal propagated between transmitter and sensor pair is compared with a corresponding reference signal (e.g., corresponding to a no touch state) to determine whether the received signal indicates that the received signal has been disturbed (e.g., difference between the received signal and the corresponding reference signal exceeds a threshold). By knowing which signal path(s) have been disturbed, the location between the transmitter and the sensor corresponding to the disturbed signal path can be identified as a location of a touch input. In another example, the propagated signal path of interest is through a thickness of a propagating medium and by using the same transducer to both transmit and receive the propagated signal, this signal path of interest is selected.

In some embodiments, determining the location includes processing the received signal and comparing the processed received signal with a calculated expected signal associated with a hypothesis touch contact location to determine whether a touch contact was received at the hypothesis location of the calculated expected signal. In some embodiments, multiple comparisons are performed with various expected signals associated with different hypothesis locations until the expected signal that best matches the processed received signal is found and the hypothesis location of the matched expected signal is identified as the touch contact location(s) of a touch input. For example, signals received by sensor transducers from one or more transmitter transducers (e.g., one or more of transducers of assembly 100) are compared with corresponding expected signals to determine a touch input location (e.g., single or multi-touch locations) that minimizes the overall difference between all respective received and expected signals.

The location, in some embodiments, is a location on the surface region where a user has provided a touch input. In addition to determining the location, one or more of the following information associated with the disturbance may be determined at 406: a gesture, simultaneous user indications (e.g., multi-touch input), a feature in a human fingerprint, a time, a status, a direction, a velocity, a force magnitude, a proximity magnitude, a pressure, a size, and other measurable or derived information. In some embodiments, the location is not determined at 406 if a location cannot be determined using the received signal and/or the disturbance is determined to be not associated with a user input. Information determined at 406 may be provided and/or outputted.

Although FIG. 4 shows receiving and processing an active signal that has been disturbed, in some embodiments, a received signal has not been disturbed by a touch input and the received signal is processed to determine that a touch input has not been detected. An indication that a touch input has not been detected may be provided/outputted.

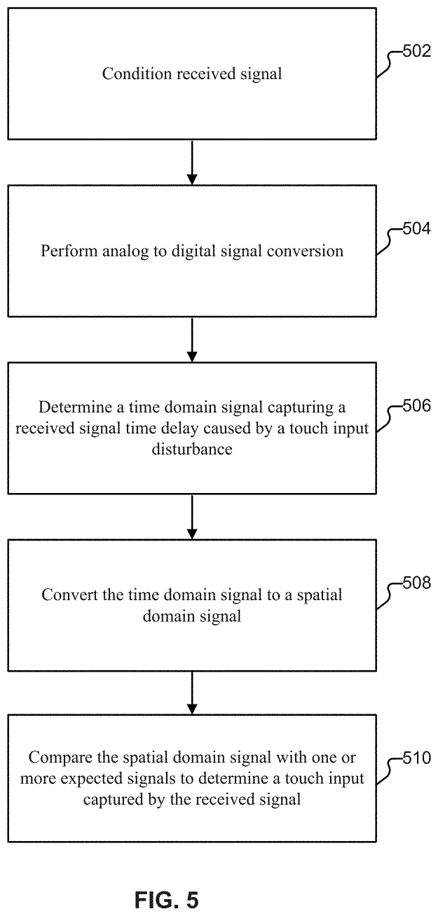

FIG. 5 is a flowchart illustrating an embodiment of a process for determining a location associated with a disturbance on a surface. In some embodiments, the process of FIG. 5 is included in 406 of FIG. 4. The process of FIG. 5 may be implemented in touch detector 120 of FIG. 1A and/or touch detector 202 of FIG. 2.

In some embodiments, at least a portion of the process of FIG. 5 is repeated for each of one or more combinations of transmitter and sensor pair. For example, for each active signal transmitted by a transmitter (e.g., transmitted by a transducer node of assembly 100), at least a portion of the process of FIG. 5 is repeated for one or more sensors (e.g., received by one or more transducer nodes of assembly 100) receiving the active signal. In some embodiments, the process of FIG. 5 is performed periodically.

At 502, a received signal is conditioned. In some embodiments, the received signal is a signal including a pseudorandom binary sequence that has been freely propagated through a medium with a surface that can be used to receive a user input. For example, the received signal is the signal that has been received at 404 of FIG. 4. In some embodiments, conditioning the signal includes filtering or otherwise modifying the received signal to improve signal quality (e.g., signal-to-noise ratio) for detection of a pseudorandom binary sequence included in the received signal and/or user touch input. In some embodiments, conditioning the received signal includes filtering out from the signal extraneous noise and/or vibrations not likely associated with a user touch indication.

At 504, an analog to digital signal conversion is performed on the signal that has been conditioned at 502. In various embodiments, any number of standard analog to digital signal converters may be used.

At 506, a time domain signal capturing a received signal time delay caused by a touch input disturbance is determined. In some embodiments, determining the time domain signal includes correlating the received signal (e.g., signal resulting from 504) to locate a time offset in the converted signal (e.g., perform pseudorandom binary sequence deconvolution) where a signal portion that likely corresponds to a reference signal (e.g., reference pseudorandom binary sequence that has been transmitted through the medium) is located. For example, a result of the correlation can be plotted as a graph of time within the received and converted signal (e.g., time-lag between the signals) vs. a measure of similarity. In some embodiments, performing the correlation includes performing a plurality of correlations. For example, a coarse correlation is first performed then a second level of fine correlation is performed. In some embodiments, a baseline signal that has not been disturbed by a touch input disturbance is removed in the resulting time domain signal. For example, a baseline signal (e.g., determined at 306 of FIG. 3) representing a measured signal (e.g., a baseline time domain signal) associated with a received active signal that has not been disturbed by a touch input disturbance is subtracted from a result of the correlation to further isolate effects of the touch input disturbance by removing components of the steady state baseline signal not affected by the touch input disturbance.

At 508, the time domain signal is converted to a spatial domain signal. In some embodiments, converting the time domain signal includes converting the time domain signal determined at 506 into a spatial domain signal that translates the time delay represented in the time domain signal to a distance traveled by the received signal in the propagating medium due to the touch input disturbance. For example, a time domain signal that can be graphed as time within the received and converted signal vs. a measure of similarity is converted to a spatial domain signal that can be graphed as distance traveled in the medium vs. the measure of similarity.

In some embodiments, performing the conversion includes performing dispersion compensation. For example, using a dispersion curve characterizing the propagating medium, time values of the time domain signal are translated to distance values in the spatial domain signal. In some embodiments, a resulting curve of the time domain signal representing a distance likely traveled by the received signal due to a touch input disturbance is narrower than the curve contained in the time domain signal representing the time delay likely caused by the touch input disturbance. In some embodiments, the time domain signal is filtered using a match filter to reduce undesired noise in the signal. For example, using a template signal that represents an ideal shape of a spatial domain signal, the converted spatial domain signal is match filtered (e.g., spatial domain signal correlated with the template signal) to reduce noise not contained in the bandwidth of the template signal. The template signal may be predetermined (e.g., determined at 306 of FIG. 3) by applying a sample touch input to a touch input surface and measuring a received signal.

At 510, the spatial domain signal is compared with one or more expected signals to determine a touch input captured by the received signal. In some embodiments, comparing the spatial domain signal with the expected signal includes generating expected signals that would result if a touch contact was received at hypothesis locations. For example, a hypothesis set of one or more locations (e.g., single touch or multi-touch locations) where a touch input might have been received on a touch input surface is determined, and an expected spatial domain signal that would result at 508 if touch contacts were received at the hypothesis set of location(s) is determined (e.g., determined for a specific transmitter and sensor pair using data measured at 306 of FIG. 3). The expected spatial domain signal may be compared with the actual spatial signal determined at 508. The hypothesis set of one or more locations may be one of a plurality of hypothesis sets of locations (e.g., exhaustive set of possible touch contact locations on a coordinate grid dividing a touch input surface).

The proximity of location(s) of a hypothesis set to the actual touch contact location(s) captured by the received signal may be proportional to the degree of similarity between the expected signal of the hypothesis set and the spatial signal determined at 508. In some embodiments, signals received by sensors from transmitters are compared with corresponding expected signals for each sensor/transmitter pair to select a hypothesis set that minimizes the overall difference between all respective detected and expected signals. In some embodiments, once a hypothesis set is selected, another comparison between the determined spatial domain signals and one or more new expected signals associated with finer resolution hypothesis touch location(s) (e.g., locations on a new coordinate grid with more resolution than the coordinate grid used by the selected hypothesis set) near the location(s) of the selected hypothesis set is determined.

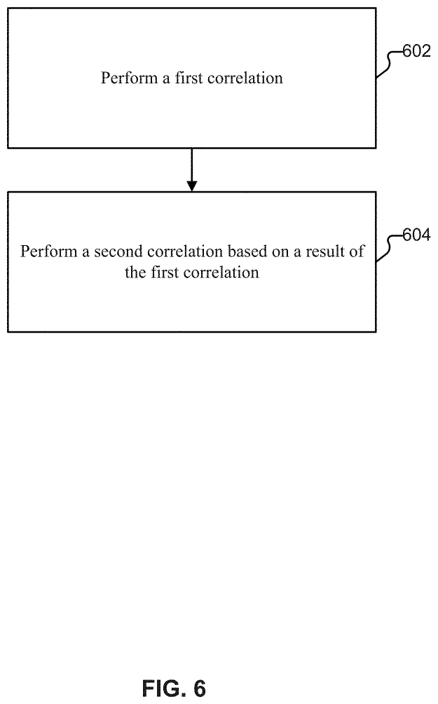

FIG. 6 is a flowchart illustrating an embodiment of a process for determining time domain signal capturing of a disturbance caused by a touch input. In some embodiments, the process of FIG. 6 is included in 506 of FIG. 5. The process of FIG. 6 may be implemented in touch detector 120 of FIG. 1A and/or touch detector 202 of FIG. 2.

At 602, a first correlation is performed. In some embodiments, performing the first correlation includes correlating a received signal (e.g., resulting converted signal determined at 504 of FIG. 5) with a reference signal. Performing the correlation includes cross-correlating or determining a convolution (e.g., interferometry) of the converted signal with a reference signal to measure the similarity of the two signals as a time-lag is applied to one of the signals. By performing the correlation, the location of a portion of the converted signal that most corresponds to the reference signal can be located. For example, a result of the correlation can be plotted as a graph of time within the received and converted signal (e.g., time-lag between the signals) vs. a measure of similarity. The associated time value of the largest value of the measure of similarity corresponds to the location where the two signals most correspond. By comparing this measured time value against a reference time value (e.g., at 306 of FIG. 3) not associated with a touch indication disturbance, a time delay/offset or phase difference caused on the received signal due to a disturbance caused by a touch input can be determined. In some embodiments, by measuring the amplitude/intensity difference of the received signal at the determined time vs. a reference signal, a force associated with a touch indication may be determined. In some embodiments, the reference signal is determined based at least in part on the signal that was propagated through a medium (e.g., based on a source pseudorandom binary sequence signal that was propagated). In some embodiments, the reference signal is at least in part determined using information determined during calibration at 306 of FIG. 3. The reference signal may be chosen so that calculations required to be performed during the correlation may be simplified. For example, the reference signal is a simplified reference signal that can be used to efficiently correlate the reference signal over a relatively large time difference (e.g., lag-time) between the received and converted signal and the reference signal.

At 604, a second correlation is performed based on a result of the first correlation. Performing the second correlation includes correlating (e.g., cross-correlation or convolution similar to step 602) a received signal (e.g., resulting converted signal determined at 504 of FIG. 5) with a second reference signal. The second reference signal is a more complex/detailed (e.g., more computationally intensive) reference signal as compared to the first reference signal used in 602. In some embodiments, the second correlation is performed because using the second reference signal in 602 may be too computationally intensive for the time interval required to be correlated in 602. Performing the second correlation based on the result of the first correlation includes using one or more time values determined as a result of the first correlation. For example, using a result of the first correlation, a range of likely time values (e.g., time-lag) that most correlate between the received signal and the first reference signal is determined and the second correlation is performed using the second reference signal only across the determined range of time values to fine tune and determine the time value that most corresponds to where the second reference signal (and, by association, also the first reference signal) matched the received signal. In various embodiments, the first and second correlations have been used to determine a portion within the received signal that corresponds to a disturbance caused by a touch input at a location on a surface of a propagating medium. In other embodiments, the second correlation is optional. For example, only a single correlation step is performed. Any number of levels of correlations may be performed in other embodiments.

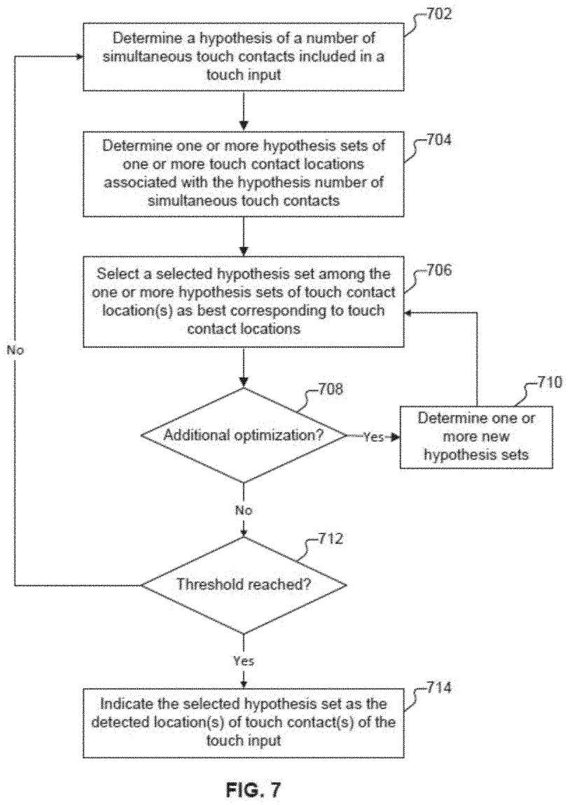

FIG. 7 is a flow chart illustrating an embodiment of a process comparing spatial domain signals with one or more expected signals to determine touch contact location(s) of a touch input. In some embodiments, the process of FIG. 7 is included in 510 of FIG. 5. The process of FIG. 7 may be implemented in touch detector 120 of FIG. 1A and/or touch detector 202 of FIG. 2.

At 702, a hypothesis of a number of simultaneous touch contacts included in a touch input is determined. In some embodiments, when detecting a location of a touch contact, the number of simultaneous contacts being made to a touch input surface (e.g., surface of medium 102 of FIG. 1A) is desired to be determined. For example, it is desired to determine the number of fingers touching a touch input surface (e.g., single touch or multi-touch). In some embodiments, in order to determine the number of simultaneous touch contacts, the hypothesis number is determined and the hypothesis number is tested to determine whether the hypothesis number is correct. In some embodiments, the hypothesis number is initially determined as zero (e.g., associated with no touch input being provided). In some embodiments, determining the hypothesis number of simultaneous touch contacts includes initializing the hypothesis number to be a previously determined number of touch contacts. For example, a previous execution of the process of FIG. 7 determined that two touch contacts are being provided simultaneously and the hypothesis number is set as two. In some embodiments, determining the hypothesis number includes incrementing or decrementing a previously determined hypothesis number of touch contacts. For example, a previously determined hypothesis number is 2 and determining the hypothesis number includes incrementing the previously determined number and determining the hypothesis number as the incremented number (i.e., 3). In some embodiments, each time a new hypothesis number is determined, a previously determined hypothesis number is iteratively incremented and/or decremented unless a threshold maximum (e.g., 10) and/or threshold minimum (e.g., 0) value has been reached.

At 704, one or more hypothesis sets of one or more touch contact locations associated with the hypothesis number of simultaneous touch contacts are determined. In some embodiments, it is desired to determine the coordinate locations of fingers touching a touch input surface. In some embodiments, in order to determine the touch contact locations, one or more hypothesis sets are determined on potential location(s) of touch contact(s) and each hypothesis set is tested to determine which hypothesis set is most consistent with a detected data.

In some embodiments, determining the hypothesis set of potential touch contact locations includes dividing a touch input surface into a constrained number of locations (e.g., divide into location zones) where a touch contact may be detected. For example, in order to initially constrain the number of hypothesis sets to be tested, the touch input surface is divided into a coordinate grid with relatively large spacing between the possible coordinates. Each hypothesis set includes a number of location identifiers (e.g., location coordinates) that match the hypothesis number determined in 702. For example, if two was determined to be the hypothesis number in 702, each hypothesis set includes two location coordinates on the determined coordinate grid that correspond to potential locations of touch contacts of a received touch input. In some embodiments, determining the one or more hypothesis sets includes determining exhaustive hypothesis sets that exhaustively cover all possible touch contact location combinations on the determined coordinate grid for the determined hypothesis number of simultaneous touch contacts. In some embodiments, a previously determined touch contact location(s) of a previous determined touch input is initialized as the touch contact location(s) of a hypothesis set.

At 706, a selected hypothesis set is selected among the one or more hypothesis sets of touch contact location(s) as best corresponding to touch contact locations captured by detected signal(s). In some embodiments, one or more propagated active signals (e.g., signal transmitted at 402 of FIG. 4) that have been disturbed by a touch input on a touch input surface are received (e.g., received at 404 of FIG. 4) by one or more sensors such as transducer nodes of assembly 100 of FIGS. 1A-1C being used as receivers. Each active signal transmitted from one or more transmitters (e.g., one or more different active signals transmitted by one or more transducer nodes of assembly 100 of FIGS. 1A-1C being used as transmitters) is received by each sensor and may be processed to determine a detected signal (e.g., spatial domain signal determined at 508 of FIG. 5) that characterizes a signal disturbance caused by the touch input. In some embodiments, for each hypothesis set of touch contact location(s), an expected signal is determined for each signal expected to be received at one or more sensors. The expected signal may be determined using a predetermined function that utilizes one or more predetermined coefficients (e.g., coefficient determined for a specific sensor and/or transmitter transmitting a signal to be received at the sensor) and the corresponding hypothesis set of touch contact location(s). The expected signal(s) may be compared with corresponding detected signal(s) to determine an indicator of a difference between all the expected signal(s) for a specific hypothesis set and the corresponding detected signals. By comparing the indicators for each of the one or more hypothesis sets, the selected hypothesis set may be selected (e.g., hypothesis set with the smallest indicated difference is selected).

At 708, it is determined whether additional optimization is to be performed. In some embodiments, determining whether additional optimization is to be performed includes determining whether any new hypothesis set(s) of touch contact location(s) should be analyzed in order to attempt to determine a better selected hypothesis set. For example, a first execution of step 706 utilizes hypothesis sets determined using locations on a larger distance increment coordinate grid overlaid on a touch input surface and additional optimization is to be performed using new hypothesis sets that include locations from a coordinate grid with smaller distance increments. Additional optimizations may be performed any number of times. In some embodiments, the number of times additional optimizations are performed is predetermined. In some embodiments, the number of times additional optimizations are performed is dynamically determined. For example, additional optimizations are performed until a comparison threshold indicator value for the selected hypothesis set is reached and/or a comparison indicator for the selected hypothesis set does not improve by a threshold amount. In some embodiments, for each optimization iteration, optimization may be performed for only a single touch contact location of the selected hypothesis set and other touch contact locations of the selected hypothesis set may be optimized in a subsequent iteration of optimization.

If at 708 it is determined that additional optimization should be performed, at 710, one or more new hypothesis sets of one or more touch contact locations associated with the hypothesis number of the touch contacts are determined based on the selected hypothesis set. In some embodiments, determining the new hypothesis sets includes determining location points (e.g., more detailed resolution locations on a coordinate grid with smaller distance increments) near one of the touch contact locations of the selected hypothesis set in an attempt to refine the one of the touch contact locations of the selected hypothesis set. The new hypothesis sets may each include one of the newly determined location points, and the other touch contact location(s), if any, of a new hypothesis set may be the same locations as the previously selected hypothesis set. In some embodiments, the new hypothesis sets may attempt to refine all touch contact locations of the selected hypothesis set. The process proceeds back to 706, whether or not a newly selected hypothesis set (e.g., if previously selected hypothesis set still corresponds best to detected signal(s), the previously selected hypothesis set is retained as the new selected hypothesis set) is selected among the newly determined hypothesis sets of touch contact location(s).

If at 708 it is determined that additional optimization should not be performed, at 712, it is determined whether a threshold has been reached. In some embodiments, determining whether a threshold has been reached includes determining whether the determined hypothesis number of contact points should be modified to test whether a different number of contact points has been received for the touch input. In some embodiments, determining whether the threshold has been reached includes determining whether a comparison threshold indicator value for the selected hypothesis set has been reached and/or a comparison indicator for the selected hypothesis set did not improve by a threshold amount since a previous determination of a comparison indicator for a previously selected hypothesis set. In some embodiments, determining whether the threshold has been reached includes determining whether a threshold amount of energy still remains in a detected signal after accounting for the expected signal of the selected hypothesis set. For example, a threshold amount of energy still remains if an additional touch contact needs be included in the selected hypothesis set.

If at 712, it is determined that the threshold has not been reached, the process continues to 702 where a new hypothesis number of touch inputs is determined. The new hypothesis number may be based on the previous hypothesis number. For example, the previous hypothesis number is incremented by one as the new hypothesis number.

If at 712, it is determined that the threshold has been reached, at 714, the selected hypothesis set is indicated as the detected location(s) of touch contact(s) of the touch input. For example, a location coordinate(s) of a touch contact(s) is provided.

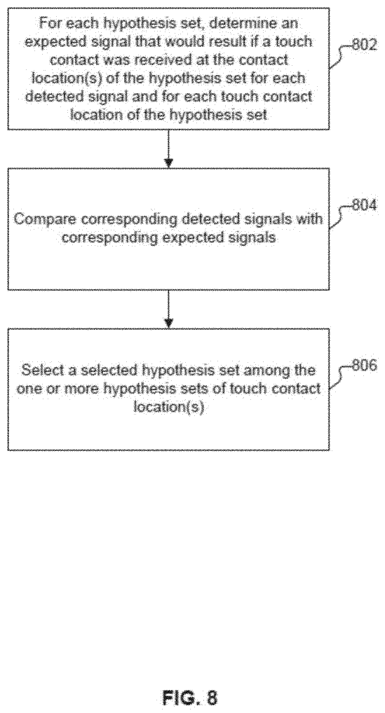

FIG. 8 is a flowchart illustrating an embodiment of a process for selecting a selected hypothesis set of touch contact location(s). In some embodiments, the process of FIG. 8 is included in 706 of FIG. 7. The process of FIG. 8 may be implemented in touch detector 120 of FIG. 1A and/or touch detector 202 of FIG. 2.

At 802, for each hypothesis set (e.g., determined at 704 of FIG. 7), an expected signal that would result if a touch contact was received at the contact location(s) of the hypothesis set is determined for each detected signal and for each touch contact location of the hypothesis set. In some embodiments, determining the expected signal includes using a function and one or more function coefficients to generate/simulate the expected signal. The function and/or one or more function coefficients may be predetermined (e.g., determined at 306 of FIG. 3) and/or dynamically determined (e.g., determined based on one or more provided touch contact locations). In some embodiments, the function and/or one or more function coefficients may be determined/selected specifically for a particular transmitter and/or sensor of a detected signal. For example, the expected signal is to be compared to a detected signal and the expected signal is generated using a function coefficient determined specifically for the pair of transmitter and sensor of the detected signal. In some embodiments, the function and/or one or more function coefficients may be dynamically determined.

In some embodiments, in the event the hypothesis set includes more than one touch contact location (e.g., multi-touch input), the expected signal for each individual touch contact location is determined separately and combined together. For example, an expected signal that would result if a touch contact was provided at a single touch contact location is added with other single touch contact expected signals (e.g., effects from multiple simultaneous touch contacts add linearly) to generate a single expected signal that would result if the touch contacts of the added signals were provided simultaneously.

In some embodiments, the expected signal for a single touch contact is modeled as the function:

C*P(x−d)

where C is a function coefficient (e.g., complex coefficient), P(x) is a function, and d is the total path distance between a transmitter (e.g., transmitter of a signal desired to be simulated) to a touch input location and between the touch input location and a sensor (e.g., receiver of the signal desired to be simulated).

In some embodiments, the expected signal for one or more touch contacts is modeled as the function:

Σⱼ₌₁^{N}CⱼP(x−dⱼ)

where j indicates which touch contact and N is the number of total simultaneous touch contacts being modeled (e.g., hypothesis number determined at 702 of FIG. 7). At 804, corresponding detected signals are compared with corresponding expected signals. In some embodiments, the detected signals include spatial domain signals determined at 508 of FIG. 5. In some embodiments, comparing the signals includes determining a mean square error between the signals. In some embodiments, comparing the signals includes determining a cost function that indicates the similarity/difference between the signals. In some embodiments, the cost function for a hypothesis set (e.g., hypothesis set determined at 704 of FIG. 7) analyzed for a single transmitter/sensor pair is modeled as:

ε(rₓ,tₓ)=|q(x)−Σⱼ₌₁^{N}CⱼP(x−dⱼ)|²

where ε(rₓ, tₓ) is the cost function, q(x) is the detected signal, and Σⱼ₌₁^{N}CⱼP(x−dⱼ) is the expected signal. In some embodiments, the global cost function for a hypothesis set analyzed for more than one (e.g., all) transmitter/sensor pairs is modeled as:

ε=Σᵢ₌₁^{Z}ε(rₓ,tₓ)ᵢ

where ε is the global cost function, Z is the number of total transmitter/sensor pairs, i indicates the particular transmitter/sensor pair, and ε(rₓ, tₓ)ᵢ is the cost function of the particular transmitter/sensor pair.

At 806, a selected hypothesis set of touch contact location(s) is selected among the one or more hypothesis sets of touch contact location(s) as best corresponding to detected signal(s). In some embodiments, the selected hypothesis set is selected among hypothesis sets determined at 704 or 710 of FIG. 7. In some embodiments, selecting the selected hypothesis set includes determining the global cost function (e.g., function ε described above) for each hypothesis set in the group of hypothesis sets and selecting the hypothesis set that results in the smallest global cost function value.

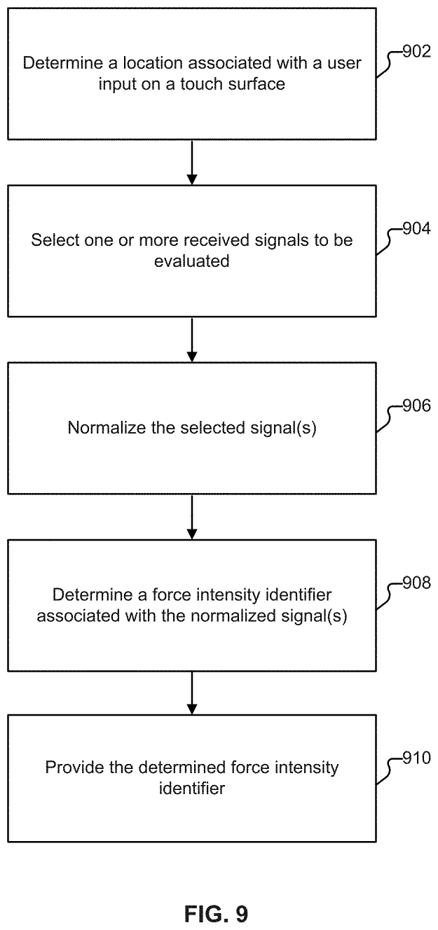

FIG. 9 is a flowchart illustrating an embodiment of a process of determining a force associated with a user input. The process of FIG. 9 may be implemented on touch detector 120 of FIG. 1A and/or touch detector 202 of FIG. 2.

At 902, a location associated with a user input on a touch input surface is determined. In some embodiments, at least a portion of the process of FIG. 4 is included in step 702. For example, the process of FIG. 4 is used to determine a location associated with a user touch input.

At 904, one or more received signals are selected to be evaluated. In some embodiments, selecting the signal(s) to be evaluated includes selecting one or more desired signals from a plurality of received signals used to detect the location associated with the user input. For example, one or more signals received in step 404 of FIG. 4 are selected. In some embodiments, the selected signal(s) are selected based at least in part on a signal-to-noise ratio associated with signals. In some embodiments, one or more signals with the highest signal-to-noise ratio are selected. For example, when an active signal that is propagated through a touch input surface medium is disturbed by a touch input, the disturbed signal is detected/received at various detectors/sensors/receivers coupled to the medium. The received disturbed signals may be subject to other undesirable disturbances such as other minor vibration sources (e.g., due to external audio vibration, device movement, etc.) that also disturb the active signal. The effects of these undesirable disturbances may be larger on received signals that were received further away from the location of the touch input.

In some embodiments, a variation (e.g., disturbance such as amplitude change) detected in an active signal received at a receiver/sensor may be greater at certain receivers (e.g., receivers located closest to the location of the touch input) as compared to other receivers. For example, in the examples of FIGS. 1A-1C, touch input provided at a surface above and between two transducer nodes affects the signal path between them. A sensor/receiver located closest to a touch input location receives a disturbed signal with the largest amplitude variation that is proportional to the force of the touch input. In some embodiments, the selected signals may have been selected at least in part by examining the amplitude of a detected disturbance. For example, one or more signals with the highest amplitude associated with a detected touch input disturbance are selected. In some embodiments, based at least in part on a location determined in 902, one or more signals received at one or more receivers located closest to the touch input location are selected. In some embodiments, a plurality of active signals is used to detect a touch input location and/or touch input force intensity. One or more received signals to be used to determine a force intensity may be selected for each of the active signals. In some embodiments, one or more received signals to be used to determine the force intensity may be selected across the received signals of all the active signals.

At 906, the one or more selected signals are normalized. In some embodiments, normalizing a selected signal includes adjusting (e.g., scaling) an amplitude of the selected signal based on a distance value associated with the selected signal. For example, although an amount/intensity of force of a touch input may be detected by measuring an amplitude of a received active signal that has been disturbed by the force of the touch input, other factors such as the location of the touch input with respect to a receiver that has received the disturbed signal and/or location of the transmitter transmitting the active signal may also affect the amplitude of the received signal used to determine the intensity of the force. In some embodiments, a distance value/identifier associated with one or more of the following is used to determine a scaling factor used to scale a selected signal: a distance between a location of a touch input and a location of a receiver that has received the selected signal, a distance between a location of a touch input and a location of a transmitter that has transmitted an active signal that has been disturbed by a touch input and received as the selected signal, a distance between a location of a receiver that has received the selected signal and a location of a transmitter that has transmitted an active signal that has been disturbed by a touch input and received as the selected signal, and a combined distance of a first distance between a location of a touch input and a location of a receiver that has received the selected signal and a second distance between the location of the touch input and a location of a transmitter that has transmitted an active signal that has been disturbed by a touch input and received as the selected signal. In some embodiments, each of one or more selected signals is normalized by a different amount (e.g., different amplitude scaling factors).

At 908, a force intensity identifier associated with the one or more normalized signals is determined. The force intensity identifier may include a numerical value and/or other identifier identifying a force intensity. In some embodiments, if a plurality of normalized signals is used, an associated force may be determined for each normalized signal and the determined forces may be averaged and/or weighted-averaged to determine the amount of the force. For example, in the case of weighted averaging of the force values, each determined force value is weighted based on an associated signal-to-noise ratio, an associated amplitude value, and/or an associated distance value between a receiver of the normalized signal and the location of the touch input.

In some embodiments, the amount of force is determined using a measured amplitude associated with a disturbed portion of the normalized signal. For example, the normalized signal represents a received active signal that has been disturbed when a touch input was provided on a surface of a medium that was propagating the active signal. A reference signal may indicate a reference amplitude of a received active signal if the active signal was not disturbed by a touch input. In some embodiments, an amplitude value associated with an amplitude change to the normalized signal caused by a force intensity of a touch input is determined. For example, the amplitude value may be a measured amplitude of a disturbance detected in a normalized signal or a difference between a reference amplitude and the measured amplitude of the disturbance detected in the normalized signal. In some embodiments, the amplitude value is used to obtain an amount/intensity of a force.

In some embodiments, the use of the amplitude value includes using the amplitude value to look up in a data structure (e.g., table, database, chart, graph, lookup table, list, etc.) a corresponding associated force intensity. For example, the data structure includes entries associating a signal disturbance amplitude value and a corresponding force intensity identifier. The data structure may be predetermined/pre-computed. For example, for a given device, a controlled amount of force is applied and the disturbance effect on an active signal due to the controlled amount of force is measured to determine an entry for the data structure. The force intensity may be varied to determine other entries of the data structure. In some embodiments, the data structure is associated with a specific receiver that received the signal included in the normalized signal. For example, the data structure includes data that has been specifically determined for characteristics of a specific receiver. In some embodiments, the use of the amplitude value to look up a corresponding force intensity identifier stored in a data structure includes selecting a specific data structure and/or a specific portion of a data structure corresponding to the normalized signal and/or a receiver that received the signal included in the normalized signal. In some embodiments, the data structure is associated with a plurality of receivers. For example, the data structure includes entries associated with averages of data determined for characteristics of each receiver in the plurality of receivers. In this example, the same data structure may be used for a plurality of normalized signals associated with various receivers.

In some embodiments, the use of the amplitude value includes using the amplitude value in a formula that can be used to simulate and/or calculate a corresponding force intensity. For example, the amplitude value is used as an input to a predetermined formula used to compute a corresponding force intensity. In some embodiments, the formula is associated with a specific receiver that received the signal of the normalized signal. For example, the formula includes one or more parameters (e.g., coefficients) that have been specifically determined for characteristics of a specific receiver. In some embodiments, the use of the amplitude value in a formula calculation includes selecting a specific formula corresponding to the normalized signal and/or a receiver that received the signal included in the normalized signal. In some embodiments, a single formula is associated with a plurality of receivers. For example, a formula includes averaged parameter values of parameter values that have been specifically determined for characteristics for each of the receivers in the plurality of receivers. In this example, the same formula may be used for a plurality of normalized signals associated with different receivers.

At 910, the determined force intensity identifier is provided. In some embodiments, providing the force intensity identifier includes providing the identifier (e.g., a numerical value, an identifier within a scale, etc.) to an application such as an application of application system 122 of FIG. 1A. In some embodiments, the provided force intensity identifier is provided with a corresponding touch input location identifier determined in step 406 of FIG. 4. In some embodiments, the provided force intensity identifier is used to provide a user interface interaction.

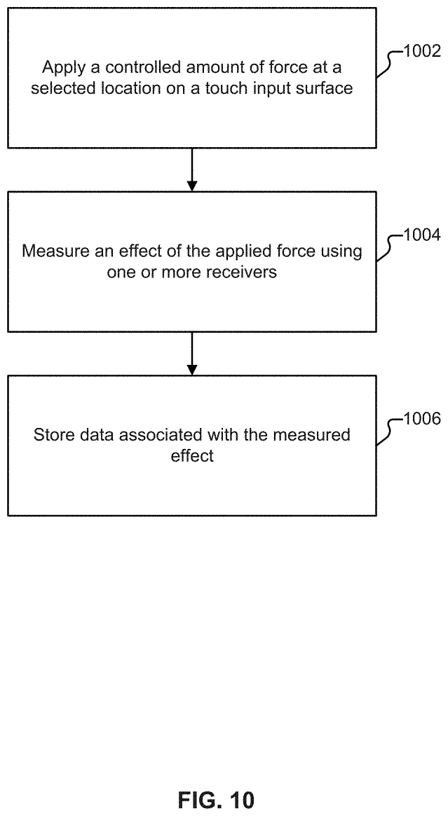

FIG. 10 is a flowchart illustrating an embodiment of a process for determining an entry of a data structure used to determine a force intensity identifier. In some embodiments, the process of FIG. 10 is included in step 304 of FIG. 3. In some embodiments, the process of FIG. 10 is used at least in part to create the data structure that may be used in step 908 of FIG. 9. In some embodiments, the process of FIG. 10 is used at least in part to calibrate the system of FIG. 1A and/or the system of FIG. 2. In some embodiments, the process of FIG. 10 is used at least in part to determine a data structure that can be included in one or more devices to be manufactured to determine a force intensity identifier/value corresponding to an amplitude value of a disturbance detected in the received active signal. For example, the data structure may be determined for a plurality of similar devices to be manufactured or the data structure may be determined for a specific device taking into account the manufacturing variation of the device.

At 1002, a controlled amount of force is applied at a selected location on a touch input surface. In some embodiments, the force is provided on a location of a surface of medium 102 of FIG. 1A where a touch input may be provided. In some embodiments, a tip of a physical human finger model is pressing at the surface with a controllable amount of force. For example, a controlled amount of force is applied on a touch input surface while an active signal is being propagated through a medium of the touch input surface. The amount of force applied in 1002 may be one of a plurality of different amounts of force that will be applied on the touch input surface.

At 1004, an effect of the applied force is measured using one or more sensor/receivers. In some embodiments, measuring the effect includes measuring an amplitude associated with a disturbed portion of an active signal that has been disturbed when the force was applied in 1002 and that has been received by the one or more receivers. The amplitude may be a directly measured amplitude value or a difference between a reference amplitude and a detected amplitude. In some embodiments, the signal received by the one or more receivers is normalized before the amplitude is measured. In some embodiments, normalizing a received signal includes adjusting (e.g., scaling) an amplitude of the signal based on a distance value associated with the selected signal.

A reference signal may indicate a reference amplitude of a received active signal that has not been disturbed by a touch input. In some embodiments, an amplitude value associated with an amplitude change caused by a disturbance of a touch input is determined. For example, the amplitude value may be a measured amplitude value of a disturbance detected in a normalized signal or a difference between a reference amplitude and the measured amplitude value of the disturbance detected in the normalized signal. In some embodiments, the amplitude value is used to obtain an identifier of a force intensity.

In some embodiments, a distance value associated with one or more of the following is used to determine a scaling factor used to scale a received signal before an effect of a disturbance is measured using the received signal: a distance between a location of a touch input and a location of a receiver that has received the selected signal, a distance between a location of the force input and a location of a transmitter that has transmitted an active signal that has been disturbed by the force input and received by the receiver, a distance between a location of the receiver and a location of a transmitter that has transmitted an active signal that has been disturbed by the force input and received by the receiver, and a combined distance of a first distance between a location of a force input and a location of the receiver and a second distance between the location of the force input and a location of a transmitter that has transmitted an active signal that has been disturbed by the force input and received by the receiver. In some embodiments, each of one or more signals received by different receivers is normalized by a different amount (e.g., different amplitude scaling factors).

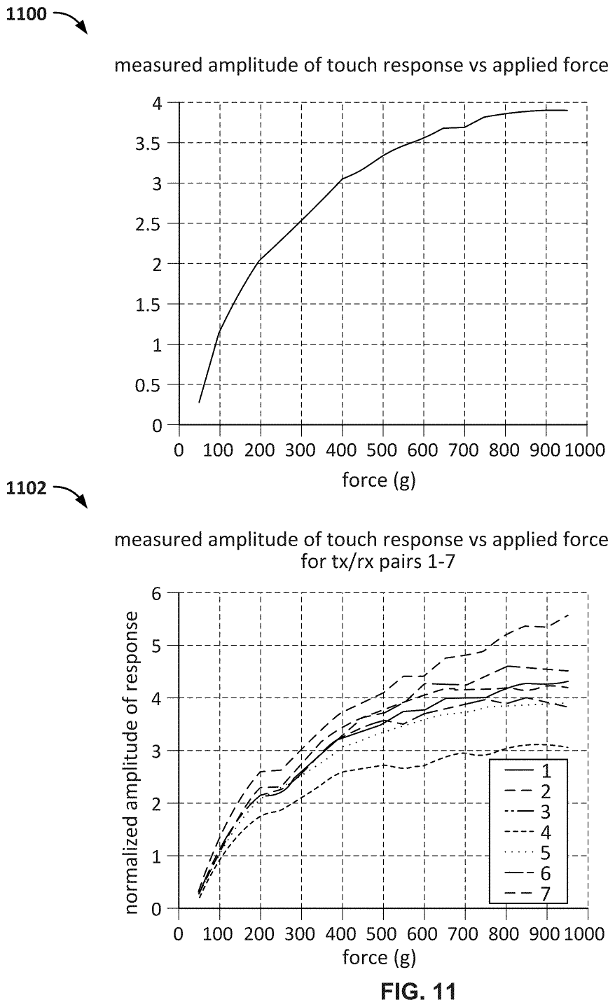

At 1006, data associated with the measured effect is stored. In some embodiments, storing the data includes storing an entry in a data structure such as the data structure that may be used in step 908 of FIG. 9. For example, an entry that associates the amplitude value determined in 1004 and an identifier associated with an amount of force applied in 1002 is stored in the data structure. In some embodiments, storing the data includes indexing the data by an amplitude value determined in 1004. For example, the stored data may be retrieved from the storage using the amplitude value. In some embodiments, the data structure is determined for a specific signal receiver. In some embodiments, a data structure is determined for a plurality of signal receivers. For example, data associated with the measured effect on signals received at each receiver of a plurality of receivers is averaged and stored. In some embodiments, storing the data includes storing the data in a format that can be used to generate a graph such as the graph of FIG. 11.

In some embodiments, the process of FIG. 10 is repeated for different applied force intensities, different receivers, different force application locations, and/or different types of applied forces (e.g., different force application tip). Data stored from the repeated execution of the steps of FIG. 10 may be used to fill the data structure that may be used in step 908 of FIG. 9.

FIG. 11 includes graphs illustrating examples of a relationship between a normalized amplitude value of a measured disturbance and an applied force. Graph 1100 plots an applied force intensity (in grams of force) of a touch input vs. a measured amplitude of a disturbance caused by the applied force for a single receiver. Graph 1102 plots an applied force intensity of a touch input vs. a measured amplitude of a disturbance caused by the applied force for different receivers. The plots of the different receivers may be averaged and combined into a single plot. In some embodiments, graph 1100 and/or graph 1102 may be derived from data stored in the data structure that may be used in step 908 of FIG. 9. In some embodiments, graph 1100 and/or graph 1102 may be generated using data stored in step 1006 of FIG. 10. Graphs 1100 and 1102 show that there exists an increasing functional relationship between measured amplitude and applied force. Using a predetermined graph, data structure, and/or formula that models this relationship, an associated force intensity identifier may be determined for a given amplitude value (e.g., such as in step 908 of FIG. 9).

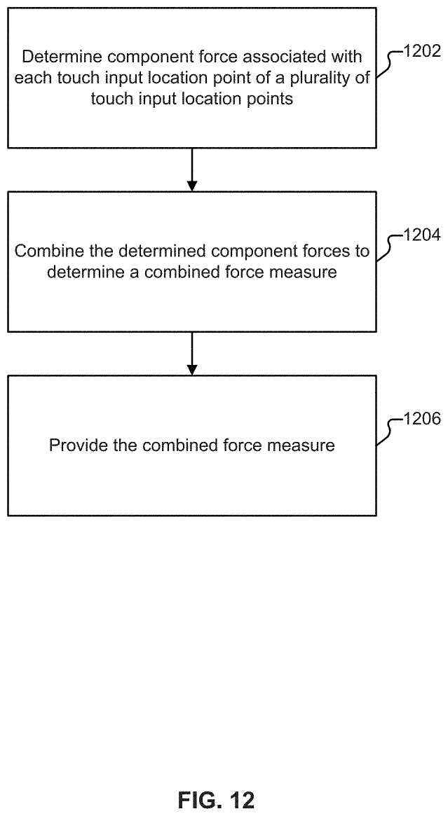

FIG. 12 is a flowchart illustrating an embodiment of a process for determining a combined force measure. The process of FIG. 12 may be implemented on touch detector 120 of FIG. 1A and/or touch detector 202 of FIG. 2.

At 1202, a component force associated with each touch input location point of a plurality of touch input location points is determined. In some embodiments, a user touch input may be represented by a plurality of touch input locations (e.g., multi-touch input, touch input covering a relatively large area, etc.). In some embodiments, for each touch input location point, at least a portion of the process of FIG. 9 is used to determine an associated force measure. For example, a force intensity identifier is determined for each input location in the plurality of touch input locations.

At 1204, the determined component forces are combined to determine a combined force measure. For example, the combined force measure represents a total amount of force applied on a touch input surface. In some embodiments, combining the determined forces includes adding a numerical representation of the forces together to determine the combined force measure. In some embodiments, a numerical representation of each determined force is weighted before being added together. For example, each numerical value of a determined force is weighted (e.g., multiplied by a scalar) based on an associated signal-to-noise ratio, an associated amplitude value, and/or an associated distance value between a receiver and a determined location of a touch input. In some embodiments, the weights of the forces being weighted must sum to the number of forces being combined.

At 1206, the combined force measure is provided. In some embodiments, providing the combined force measure includes providing a force intensity identifier to an application such as an application of application system 122 of FIG. 1A. In some embodiments, provided combined force is used to provide a user interface interaction. In an alternative embodiment, rather than providing the combined force, the determined forces for each touch input location point of a plurality of touch input location points are provided.

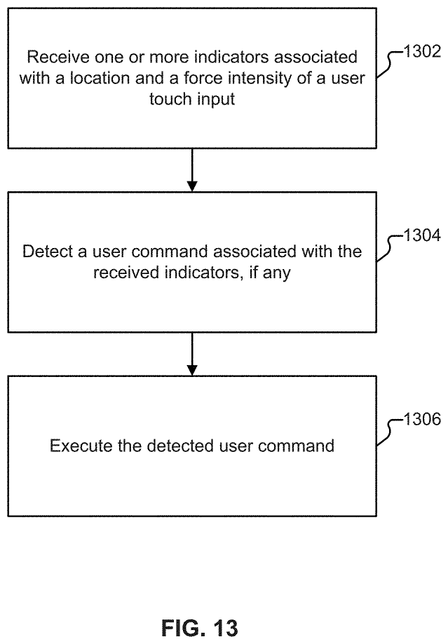

FIG. 13 is a flowchart illustrating an embodiment of a process for processing a user touch input. The process of FIG. 13 may be implemented on application system 122 of FIG. 1A.

At 1302, one or more indicators associated with a location and a force intensity of a user touch input are received. In some embodiments, the indicator(s) include data provided in step 910 of FIG. 9 and/or step 1206 of FIG. 12. The location may indicate a location (e.g., one-dimensional location) on a surface of a side of a device. In some embodiments, indicators associated with a sequence of locations and associated force intensities are received. In some embodiments, the one or more indicators are provided by touch detector 120 of FIG. 1A.

At 1304, a user command associated with the received indicators, if any, is detected. For example, a user presses a specific location on the touch input surface with sufficient force to provide a user command. Because the user touch input may be indicated on sidewalls of a device, it may be necessary to determine whether a touch detected on the side surface of a device is a user command or a user simply holding/touching the device without a desire to provide a user command. In some embodiments, in order to distinguish between a user command and a non-command touch, a command is only registered if a detected touch was provided with sufficient force and/or speed. For example, detected touches below a threshold force and/or speed are determined to be not a user command input and ignored.

In some embodiments, one or more different regions of one or more touch input surfaces are associated with different user commands and a location of a touch input is utilized to identify which command has been indicated. For example, locations/regions along one or more sides of a device have been mapped to different corresponding functions/commands. In order to indicate a specific function/command, the user may provide a gesture input (e.g., press, swipe up, swipe down, pinch in, pinch out, double tap, triple tap, long press, short press, rub, etc.) with sufficient force at the location associated with the specific function/command.

In some embodiments, for a given area/region of a touch input area, different types of gestures (e.g., press, swipe up, swipe down, pinch in, pinch out, double tap, triple tap, long press, short press, rub, etc.) provided in the same region may correspond to different user commands. For example, swiping up in a touch input area increases a volume and swiping down in the same touch input area decreases a volume.

In some embodiments, the amount of force of the user indication may correspond to different user commands. For example, although the amount of force must be greater than a threshold value to indicate a user command, the amount of force (e.g., once it meets the threshold) may correspond to different commands based on additional force thresholds (e.g., force above a first threshold and below a second threshold indicates a primary click and force greater than the second threshold indicates a secondary click) and/or a magnitude value of the user command.

In some embodiments, the speed of the user indication on the touch input surface may be varied to indicate different user commands. For example, a speed of a swipe touch gesture indicates a speed of scrolling. In some embodiments, the number of simultaneous user touch indications (e.g., number of fingers) and their locations (e.g., respective locations/areas/regions of the user indications) may be varied to indicate different user commands.

In some embodiments, once the user command has been successfully identified, a confirmation indication is provided to indicate to a user that the user command has been successfully detected. For example, a visual (e.g., visual flash), an audio (e.g., chime), and/or a tactile (e.g., vibration/haptic feedback) indication is provided upon successfully detecting the user command.

At 1306, the detected user command is executed. For example, the identified user command is provided to an application and/or operating system for execution/implementation.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
an assembly configured to be coupled to a propagating medium and comprising:
a first conductive layer including a first set of parallel conductors;
a second conductive layer including a second set of parallel conductors; and
a piezoelectric material layer between the first conductive layer and the second conductive layer;
wherein different piezoelectric transducer nodes are formed at intersections between the first set of parallel conductors and the second set of parallel conductors.

2. The system of claim 1, wherein the first set of parallel conductors are oriented perpendicular to the second set of parallel conductors.

3. The system of claim 1, wherein the first set of parallel conductors and the second set of parallel conductors are made of a transparent conductive oxide.

4. The system of claim 1, wherein the piezoelectric material layer is lead-free and includes aluminum nitride.

5. The system of claim 1, further comprising a multiplexing circuitry implemented using thin-film driver transistors of a display, wherein the multiplexing circuitry is configured to selectively connect a signal driver to a selected conductor among at least the first set of parallel conductors.

6. The system of claim 1, wherein the piezoelectric material layer is patterned to form a grid of separate piezoelectric material portions for the different transducer nodes formed at the intersections between the first set of parallel conductors and the second set of parallel conductors.

7. The system of claim 1, wherein the propagating medium includes a cover glass of an electronic display.

8. The system of claim 1, further comprising:
an electronic circuitry electrically connected to the assembly and configured to:
provide an electrical input to cause at least one of the different piezoelectric transducer nodes of the assembly to propagate a signal through the propagating medium;
receive a disturbed version of the propagated signal; and
analyze the received disturbed signal to detect a touch input on the propagating medium.

9. The system of claim 8, wherein the electronic circuitry is individually connected to each of the first set of parallel conductors and each of the second set of parallel conductors.

10. The system of claim 8, wherein the electrical input includes a positive component signal of a differential signal applied to one of the first set of parallel conductors and a negative component signal of the differential signal applied to one of the second set of parallel conductors.

11. The system of claim 8, wherein the electrical input includes a component signal of a differential signal applied to a selected one of the first set of parallel conductors and an opposite version of the component signal applied to a different one of the first set of parallel conductors.

12. The system of claim 8, wherein the propagated signal encodes a pseudo random binary signal.

13. The system of claim 8, wherein a same transducer node of the assembly is configured to both propagate the signal through the propagating medium and detect the disturbed version of the propagated signal.

14. The system of claim 8, wherein the assembly is configured to concurrently propagate through the propagating medium a plurality of different encoded signals.

15. The system of claim 8, wherein the detecting the touch input includes determining a location of the touch input.

16. The system of claim 8, wherein the detecting the touch input includes determining a force of the touch input.

17. The system of claim 8, wherein the detecting the touch input includes detecting features of a fingerprint.

18. The system of claim 8, wherein the electronic circuitry is configured to detect a change in capacitance caused on the assembly by the touch input.

19. A method, comprising:
providing an electrical input to cause at least one of different piezoelectric transducer nodes of a piezoelectric transducer array assembly to propagate a signal through a propagating medium;
receiving a disturbed version of the propagated signal; and
analyzing the received disturbed signal to detect a touch input on the propagating medium;
wherein the piezoelectric transducer array assembly includes: a first conductive layer including a first set of parallel conductors, a second conductive layer including a second set of parallel conductors, and a piezoelectric material layer between the first conductive layer and the second conductive layer; and
wherein the different piezoelectric transducer nodes are formed at intersections between the first set of parallel conductors and the second set of parallel conductors.

20. A system, comprising:
an integrated circuit configured to:
provide an electrical input to cause at least one of different piezoelectric transducer nodes of a piezoelectric transducer array assembly to propagate a signal through a propagating medium;
receive a disturbed version of the propagated signal; and
analyze the received disturbed signal to detect a touch input on the propagating medium;
wherein the piezoelectric transducer array assembly includes: a first conductive layer including a first set of parallel conductors, a second conductive layer including a second set of parallel conductors, and a piezoelectric material layer between the first conductive layer and the second conductive layer; and
wherein the different piezoelectric transducer nodes are formed at intersections between the first set of parallel conductors and the second set of parallel conductors.
